(19) United States
(12) Patent Application Publication
(10) Pub. No.: US 2026/0177368 A1
(43) Pub. Date: Jun. 25, 2026

(54) DRAW WIRE SENSOR

(71) Applicant: Dana Motion Systems Italia S.R.L., Reggio Emilia (IT)

(72) Inventors: Pier Paolo RINALDI, Arco (IT); Matteo DALLAPICCOLA, Trento (IT); MariaDomenica ROMANO, Modena (IT)

(21) Appl. No.: 19/001,156

(22) Filed: Dec. 24, 2024

(51) Int. Cl. G01B 5/04; B66C 13/46; B66D 1/40

(52) U.S. Cl. CPC G01B 5/043; B66D 1/40; B66C 13/46

(57) ABSTRACT

Systems and methods are herein provided for a draw wire sensor. In one example, a draw wire sensor comprises a shell comprising an input hole; a drum mounted to the shell and installed on a rotating shaft; a plurality of roller pin assemblies arranged around the drum; a draw wire configured to enter through the input hole and wind around the plurality of roller pins before winding around the drum; and a sensor device coupled to the rotating shaft and positioned to measure linear distances based on the winding of the draw wire around the drum.

### TECHNICAL FIELD

Embodiments of the subject matter disclosed herein relate to draw wire sensors, and more particularly to a draw wire sensor with an enhanced winding feature allowing for spiral-shaped multi-layer wire winding.

### BACKGROUND AND SUMMARY

In various industrial construction vehicles and cranes, precise measurement of displacement and extension of moving parts, such as booms, trolleys, and hooks, is essential. For example, the position or extension of mechanical elements, such as telescopic booms, is measured to accurately determine the center of gravity, considering the movement of the load. One of the most widely used devices to perform measurement of displacement or extension is a draw wire position sensor. Draw wire sensors, also called string potentiometers or cable extension transducers, are typically used for measuring linear distances.

Draw wire sensors operate by winding a wire onto a drum, wherein the angle and number of rotations of the drum are measured through various systems, such as potentiometer-based systems, encoders, and other similar technologies. For example, the wire is attached to the moving part of the vehicle and is wound onto a spring-loaded drum inside the draw wire sensor housing. As the moving component moves, the draw wire extends or retracts, rotating the drum. The rotation of the drum is then converted into an electrical signal that corresponds to the position or length of extension.

However, improper winding of the wire around the drum can lead to various issues. For example, uneven wrapping can cause overlapping layers of the wire around the drum, which may lead to the wire becoming tangled or kinked. This increases wear and tear, reducing the lifespan of the wire. Further, improperly wrapped wires can cause fluctuations in the sensor's readings, leading to inaccurate measurements. Further still, poorly wrapped wire can jam the spool mechanism, leading to mechanical failure, resulting in demand for maintenance, repair, or replacement.

One of the design parameters that affects the winding of the wire is the angle swept by the winding wire, referred to as the deflection angle. The deflection angle may be understood as the widest angle swept between an input hole and the point of contact with the drum. Too wide of a deflection angle may result in poorly wound wires, which as described can compromise the sensor's accuracy and longevity.

The deflection angle is directly related to the distance between the input hole and the point of contact with the drum, herein referred to as the free wire length. For example, a longer free wire length may result in a smaller deflection angle, which may help to mitigate issues with wire winding. Current methods for increasing the distance between the input hole and the point of contact with the drum include a protuberance design, whereby the input hole on the housing of the sensor is located far away from the drum, creating a protuberance, and an extended input hole design that allows for a variable input point and therefore a variable distance. The protuberance design increases the overall footprint of the sensor, especially in the direction of the protuberance, making it bulkier and awkwardly shaped. The extended input hole design compromises the sensor's ability to keep out dirt, dust, moisture, and other contaminants, potentially affecting its reliability and accuracy. Thus, both methods aim to optimize the deflection angle, but they come with trade-offs in terms of sensor size and exposure to the environment.

The inventors herein have recognized the aforementioned issues and developed a draw wire sensor that at least partially addresses the aforementioned issues. For example, the draw wire sensor herein described includes a plurality of pins that function as idler pulleys around the sensor drum. The wire may be fed through an input hole, and around the plurality of pins before contacting the drum to be wound around the drum. Thus, the draw wire sensor herein disclosed has an effectively increased distance between the input hole and the point of contact with the drum without increasing the overall footprint of the sensor and without exposing the sensor to the environment. The increased distance may thus result in a smaller deflection angle, which in turn may increase the overall accuracy and longevity of the sensor by mitigating wrapping issues.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic diagram of a crane application including a draw wire sensor.

FIG. 2 shows a perspective view of a draw wire sensor.

FIG. 3 shows a top down view of the draw wire sensor.

FIG. 4 shows a first lateral view of the draw wire sensor.

FIG. 5 shows a second lateral view of the draw wire sensor.

FIG. 6 shows a third lateral view of the draw wire sensor.

FIG. 7 shows a cross-sectional view of the draw wire sensor within a housing.

FIG. 8 shows a perspective view of the draw wire sensor within the housing.

FIG. 9A-9B show example diagrams illustrating deflection angle of conventional draw wire sensors.

FIG. 10 shows a flowchart illustrating a method for determining displacement of a movable part with the draw wire sensor.

### DETAILED DESCRIPTION

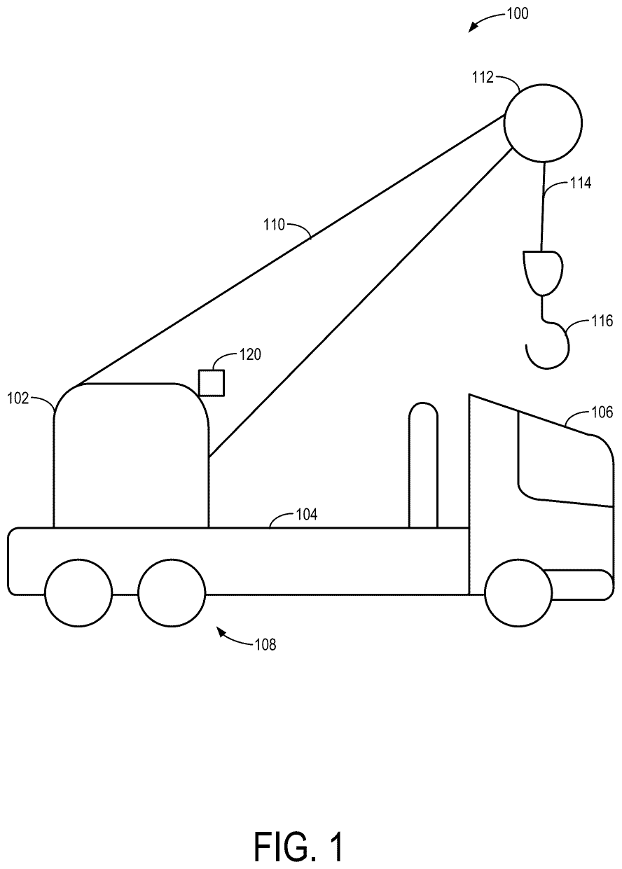

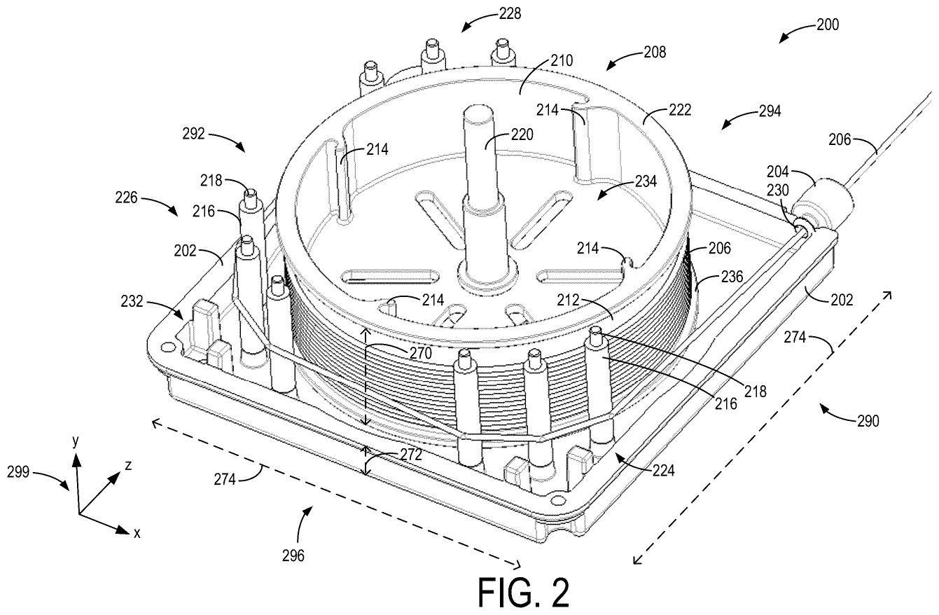

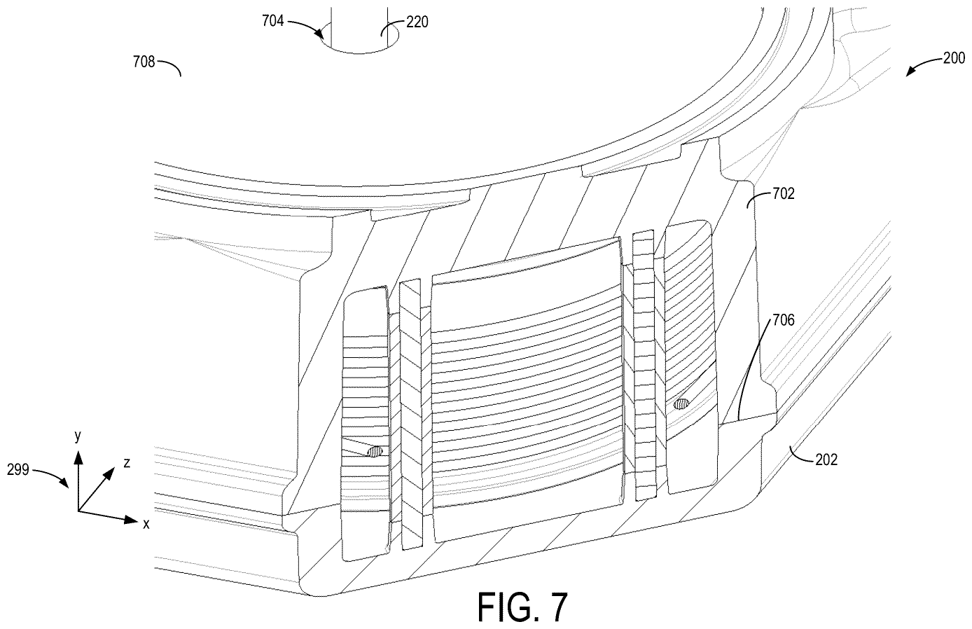

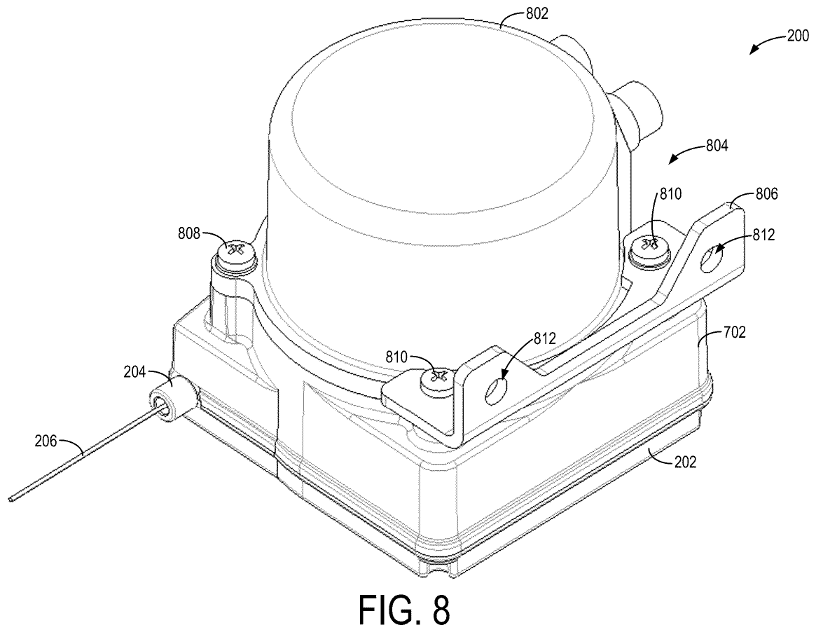

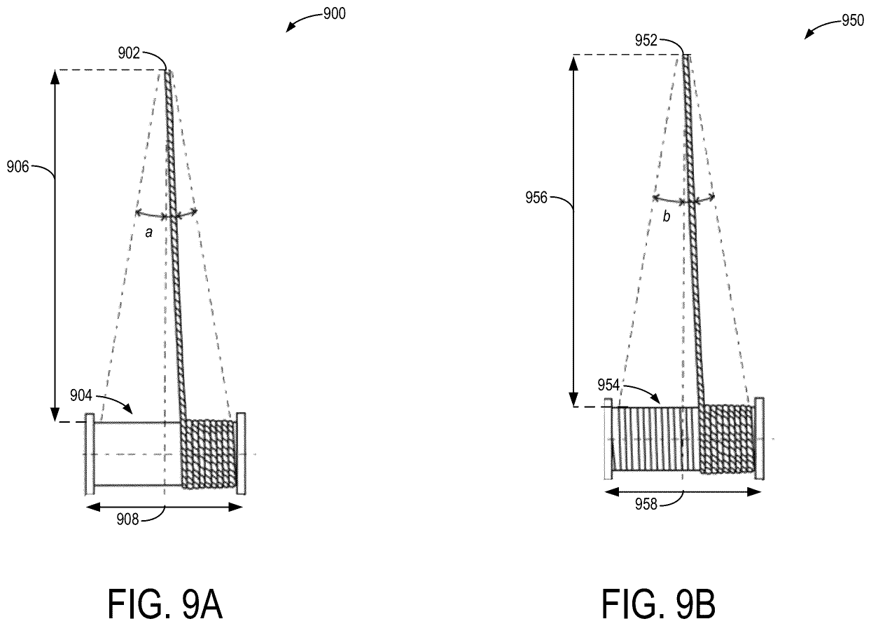

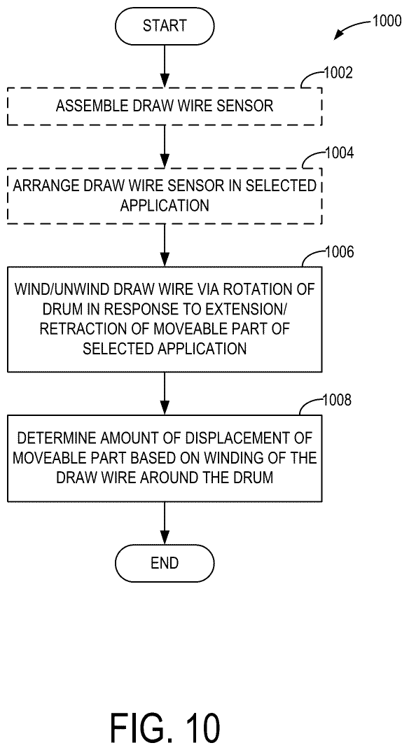

The following description relates to systems for a draw wire sensor. In particular, a draw wire sensor with an enhanced winding feature including a spiral-shaped multi-layer winding of the wire that allows for decreased deflection angle. As is described herein, improper winding of the wire around the drum can lead to various issues, including tangling, kinking, and jamming, which may reduce the longevity of the sensor and reduce accuracy and reliability of the sensor's readings. The deflection angle is a parameter affecting the winding of the wire, wherein a too wide angle may result in winding issues. The distance between the input hole of the sensor housing and the point of contact of the wire with the drum, dubbed herein as the free wire length or free cable length, is one parameter that defines the deflection angle. The draw wire sensor herein disclosed decreases deflection angle by increasing the free wire length as a result of first winding the wire around a plurality of pins. FIG. 1 shows an exemplary crane application in which the draw wire sensor herein disclosed may be incorporated. FIGS. 2-6 show various views of the draw wire sensor and FIGS. 7-8 show view of the draw wire sensor within a housing. FIGS. 9A and 9B show example convention draw wire sensors illustrating deflection angle and free wire length, for context. FIG. 10 shows a flowchart illustrating a method for determining displacement of a movable part (e.g., a boom of a crane) with the draw wire sensor.

Starting with FIG. 1, a crane 100 is shown. The crane 100 is an example of a suitable application into which a draw wire sensor may be incorporated for measurement of displacement or extension of a movable part.

The crane 100 includes a main crane body 102 that is mounted on a chassis 104. An operator cab 106 is also mounted on the chassis 104. The crane 100 is propelled by wheels 108 and a power source, such as an engine, battery, or the like (not shown). The main crane body 102 may be coupled to a boom 110. While not specifically shown in FIG. 1, the boom 110 may be extendable, such as a telescopic boom that has multiple sections configured to extend and retract to alter the length thereof. In the example crane shown, the boom 110 may be coupled to a winch 112 which winds and extends a hoist cable 114 connected to a hook 116.

A displacement sensor 120 may be coupled to the extendable boom 110. In some examples, the displacement sensor 120 may be a draw wire sensor that comprises a dedicated wire or cable that is attached to a moving part of the boom 110 (e.g., one of the telescopic sections). As the boom 110 extends or retracts, the wire of the displacement sensor 120 winds or unwinds, allowing a sensor device of the displacement sensor 120 to measure the extension, displacement, or position of the boom. The sensor device, as is herein described, may be a rotary encoder, a potentiometer, or other similar device configured to measure rotation of the drum and determine from the rotation measurement a linear displacement of the extendable boom 110.

The extension, displacement, or position of the boom may be determined by the displacement sensor 120 based on the angle and number of rotations of a drum of the displacement sensor 120 in various manners. For example, the relationship between the drum rotation and the cable extension may be determined based on the drum's circumference and the number of full rotations of the drum, which may inform the length of the wire that is extended or retracted. A rotary encoder or potentiometer attached to the drum may inform the angular displacement of the drum in degrees or radians and a counter may track the number of rotations and/or partial rotations the drum has undergone, therefore indicating the length of the wire that is extended or retracted. It should be understood however that other methods for determining displacement are possible without departing from the scope of this disclosure.

The displacement sensor 120 as will be herein described thus operates by winding and unwinding a wire around a drum. One of the parameters that affects the winding of the displacement sensor 120 is the deflection angle of the wire. Turning briefly to FIGS. 9A and 9B, examples of conventional draw wire sensors are shown to illustrate deflection angle and the parameters that define deflection angle. Specifically, in FIG. 9A, a draw wire sensor 900 with a smooth drum is shown and in FIG. 9B, a draw wire sensor 950 with a grooved drum is shown.

The deflection angle of a draw wire sensor may be defined according to a free wire length and a drum length. The deflection angle of a draw wire sensor is the widest sweep angle of the winding wire. For example, the draw wire sensor 900 of FIG. 9A has a deflection angle a defined by free wire length 906 and drum face width 908. The free wire length 906 may be the distance between an input hole, represented in FIG. 9A by point 902, and a point of contact between the wire and the drum, represented in FIG. 9A by drum edge 904. Similarly, the draw wire sensor 950 of FIG. 9B has a deflection angle b defined by free wire length 956 and drum face width 958. The free wire length 956 may be the distance between an input hole, represented in FIG. 9B by point 952, and a point of contact between the wire and the drum, represented in FIG. 9B by drum edge 954.

As a non-limiting example, the largest deflection angle that is suitable for a smooth drum application, as illustrated in FIG. 9A may be 1.3 degrees, while the largest deflection angle that is suitable for a grooved application, as illustrated in FIG. 9B, may be 2 degrees. It should be understood that other suitable deflection angles are possible without departing from the scope of this disclosure. Exceeding the suitable deflection angle can lead to wrapping problems or wire degradation, which can compromise the sensor's accuracy and longevity. The draw wire sensor herein disclosed provides a decreased deflection angle by increasing the free wire length with a plurality of pins, as will be herein described with respect to FIGS. 2-6.

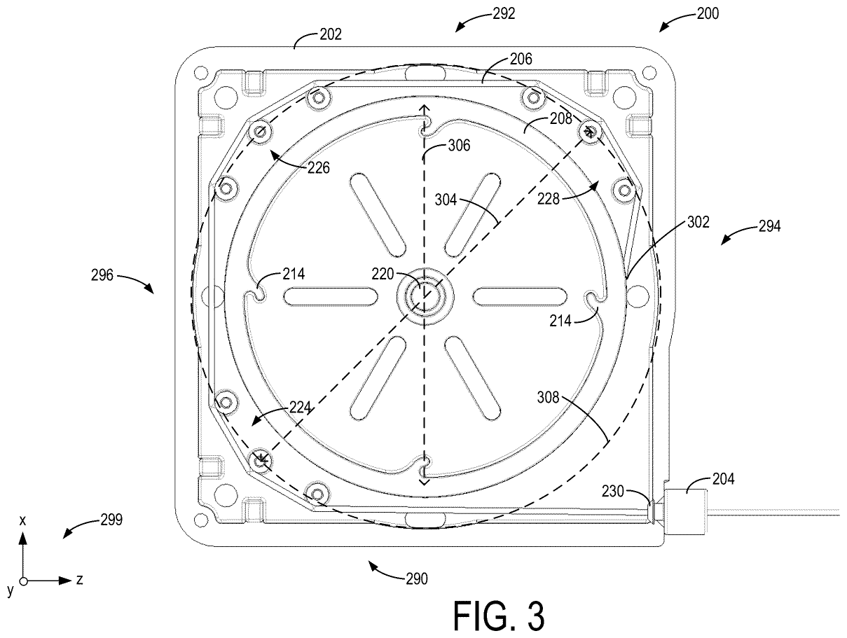

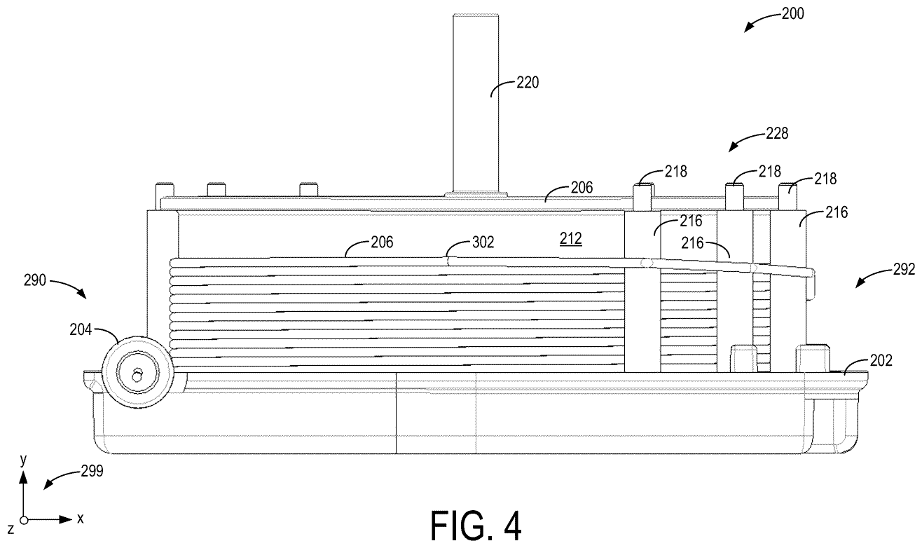

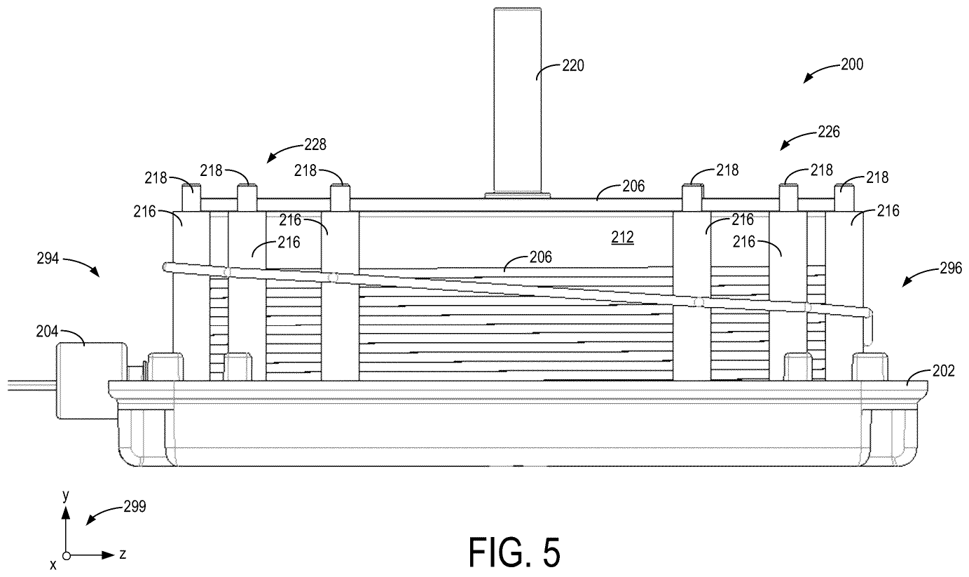

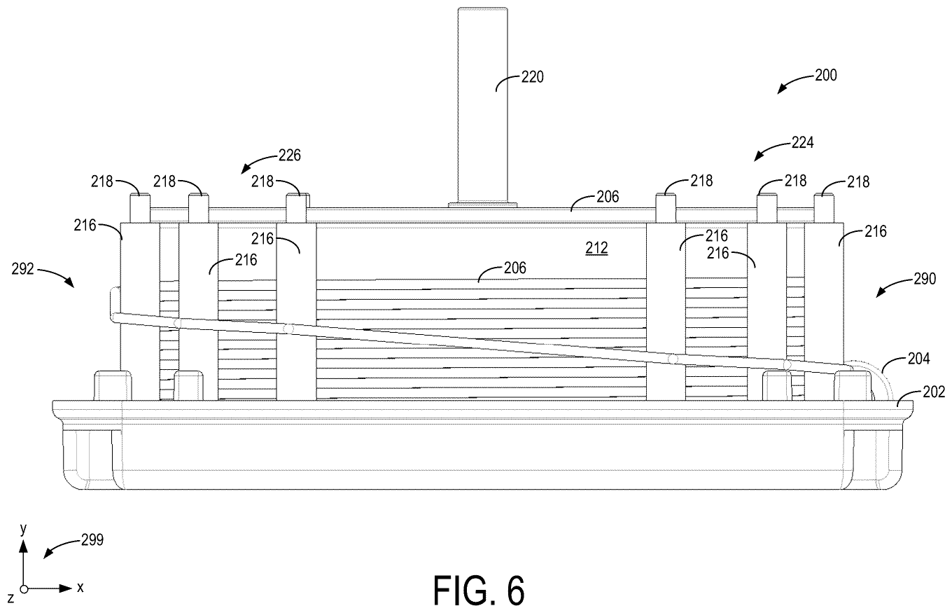

Turning now to FIGS. 2-6, a draw wire sensor 200 according to one or more embodiments of the present disclosure is shown from various views. FIG. 2 shows the draw wire sensor 200 from a perspective view, FIG. 3 shows the draw wire sensor 200 from a top down view, FIG. 4 shows the draw wire sensor 200 from a first lateral view, FIG. 5 shows the draw wire sensor 200 from a second lateral view, and FIG. 6 shows the draw wire sensor from a third lateral view. An axis system 299 is provided in FIGS. 2-6 (and FIGS. 7-8) for reference. An x-axis may be a lateral axis, a y-axis may be a vertical axis, and a z-axis may be a longitudinal axis, though other axes are possible. Further, it should be understood that the draw wire sensor 200 may be incorporated into a vehicle application in different orientations than shown in the FIGS. 2-8.

The draw wire sensor 200 as shown in FIGS. 2-6 may comprise a shell 202 and a drum 208 that may be mounted to an inner surface of the shell 202. The shell 202 may be roughly rectangular shaped, for example a square shape, with a first side 290, a second side 292 opposite the first side 290, a first end 294 and a second end 296 opposite the first end 294. Each of the first side 290, the second side 292, the first end 294, and the second end 296 may be of a length 274. The shell 202 may have a depth 272, thus the shell may be a rectangular shaped open box configuration. The shell 202 may include an input hole 230. The input hole 230 may be configured to receive draw wire 206. For example, the input hole 230 may be configured as a circle with a diameter that is larger than a diameter of the draw wire 206. For example, the diameter of the input hole 230 may be 1.5 times as large as the diameter of the draw wire 206.

The input hole 230 may be normal to the first end 294 and may extend through the thickness of the shell 202 along the first end 294, closer to the first side 290 than the second side 292. For example, the input hole 230 may be within 10% of a length of the first end 294 from the edge (e.g., vertex) between the first end 294 and the first side 290. In some examples, the input hole 230 may be positioned midway along a width 270 of the drum 208 (also considered a height of the drum depending on the considered axes). The width 270 of the drum 208 may be less than the length 274 of the shell 202 such that the drum 208 may fit within an inner area of the shell 202.

A separating cylinder 204 may be positioned at an external surface of the shell 202 circumferentially about the input hole 230. The separating cylinder 204 may mitigate direct contact between the draw wire 206 and the shell 202 to minimize friction therebetween. The separating cylinder 204 may also mitigate contaminant particles like dirt and dust from entering the draw wire sensor 200 through the input hole 230.

In some examples, the shell 202 may include a plurality of molded protrusions 232 that are formed during the forming of the shell 202. As will be further described with respect to FIGS. 7-8, the plurality of molded protrusions 232 may be formed to mate with sections of a housing of the draw wire sensor 200.

The drum 208 may include an inner surface 210 and an outer surface 212. The inner surface 210 may include a plurality of latching protrusions 214. The latching protrusions 214, in one example, may be shaped as hooks that span the height of the drum 208, to an upper lip 222. The drum 208 may be installed on a rotating shaft 220. For example, the drum 208 may be installed around the rotating shaft 220 and then held in place by a torsional spring 234 that is locked into place within the drum 208 by the plurality of latching protrusions 214. For example, the torsional spring 234 may comprise indentions that contact the plurality of latching protrusions 214 to maintain the relative positions of the drum 208 and the torsional spring 234. The torsional spring 234 may also act to maintain tension of the wire wrapped around the drum 208.

The draw wire sensor 200 may further comprise a plurality of pins 216. Each of the plurality of pins 216 may be inserted into and/or mounted within protrusions or recesses (not shown) of the shell 202. A plurality of rollers 218 may be nested around the plurality of pins 216, forming a plurality of roller pin assemblies, each including one pin and one roller. For example, one of the plurality of rollers 218 may be nested around a corresponding one of the plurality of pins 216. In some examples, there may be at least six roller pin assemblies. In the example shown in FIGS. 2-6, the draw wire sensor 200 includes nine roller pin assemblies.

The plurality of rollers may be freely rotatable around the corresponding pins. Thus, the plurality of rollers 218 may act as borderless pulleys for the draw wire. The plurality of rollers 218 may rotate about axes that are parallel with an axis of rotation of the drum 208. The plurality of rollers 218 may also be mounted on protrusions or within the shell 202 such that the plurality of rollers 218 may maintain their relatively centered position around the corresponding pins with a minimal functional clearance to allow for rotation of the rollers around the pins.

In some examples, the plurality of pins 216 and the plurality of rollers 218 (e.g., the plurality of roller pin assemblies) may be grouped into sets. For example, as is shown in FIGS. 2-6, a first set of roller pin assemblies 224, a second set of roller pin assemblies 226, and a third set of roller pin assemblies 228. The first set of roller pin assemblies 224 may be positioned spanning a rounded corner section from the first side 290 to the second end 296 (e.g., at a first vertex). For example, a first roller pin assembly of the first set of roller pin assemblies may be positioned near the first side 290, a second roller pin assembly of the first set of roller pin assemblies may be positioned in line with a vertex between the first side 290 and the second end 296, and a third roller pin assembly of the first set of roller pin assemblies is positioned near the second end 296. The second set of roller pin assemblies 226 may be positioned spanning a rounded corner section from the second end 296 to the second side 292 (e.g., at a second vertex) and the third set of roller pin assemblies 228 may be positioned spanning a rounded corner section from the second side 292 to the first end 294 (e.g., at a third vertex) in a similar fashion to as described with respect to the first set of roller pin assemblies 224. In some examples, the input hole 230 may be positioned near a fourth vertex, thus the input hole 230 may be arranged not at the same vertex as one of the sets of roller pins in some examples. It should be understood however, that in some examples additional sets of roller pins may be included and may overlap, in a spiral pattern, the input hole and/or the first, second, and/or third sets of roller pins to further increase the free wire length.

A curve created by each of the sets of pins may generally follow a corresponding arc of the drum 208. The plurality of pins 216 may be positioned around the outer surface 212 of the drum 208. For example, the plurality of roller pin assemblies may generally follow a circular path 308, as shown in FIG. 3. The circular path 308 that the plurality of roller pin assemblies follows may have a first diameter 304 while the drum 208, which is also circular in shape, may have a second diameter 306 that is smaller than the first diameter 304. The circular path 308 of the plurality of roller pin assemblies may have a center that is the same as the center of the drum 208 (e.g., where the rotating shaft 220 is positioned).

In assembly of the draw wire sensor 200, an end of the draw wire 206 may be affixed to a chosen point of the outer surface 212 of the drum 208. The chosen point of the outer surface 212 of the drum 208 may be at a midpoint of its face width 270 at the same end as the input hole 230 (e.g., the first end 294). The draw wire 206 may then be wrapped around the outside of the plurality of rollers 218, first passing around the third set of roller pin assemblies 228, then around the second set of roller pin assemblies 226, and finally around the first set of roller pin assemblies 224 before exiting the draw wire sensor 200 via the input hole 230. The plurality of rollers 218 may have the same height as the face width 270 of the drum 208, thereby minimizing winding issues that would result from the wire winding around the rollers higher than the drum. The input hole 230 may be positioned more towards the first side 290 insofar that the draw wire 206 is driven by the rollers/pins around the circular path 308 (e.g., starting with the first set of roller pin assemblies 224), and thus around the first diameter 304, before contacting the drum 208, as at least a first roller pin assembly is positioned near the first side 290.

When more of the draw wire 206 is fed into the draw wire sensor 200 via the input hole 230 and the drum 208 rotates about the rotating shaft 220, the draw wire 206 may pass around the outside of the plurality of rollers 218 before contacting the drum 208. This, in effect, increases the free wire length of the draw wire sensor 200, which in turn may decrease the deflection angle of the draw wire.

The deflection angle may be approximated by equation (1):

$$arctan ( \frac{W}{2 π {D}_{1}} ) \qquad ( 1 )$$

where W is the drum width (e.g., width 270) and D₁ is the diameter of the circle defined by the plurality of roller pin assemblies (e.g., first diameter 304).

In the top down view of the draw wire sensor 200 as shown in FIG. 3, a point of contact 302 is indicated. The point of contact 302 may be the affixation point in examples in which the draw wire 206 is initially assembled within the draw wire sensor 200 and the draw wire is fully extended. In other examples, the point of contact 302 may be the first point at which the free wire entering the sensor contacts the drum 208. In particular, as shown, the point of contact 302 may be towards the first end 294, near a midpoint between the first and second sides 290, 292. The draw wire 206 entering through the input hole 230 may pass around the first, second, and third sets of roller pin assemblies 224, 226, 228 before reaching the point of contact 302. Thus, the distance between the input hole 230 and the point of contact 302 may be increased. In contrast, in conventional draw wire sensors that do not include such a mechanism of decreasing the deflection angle, the point of contact between the end of the free wire and the drum may be closer to the input hole, for example along the first side 290 of the drum. From the contact point, the draw wire 206 may be wound around the drum 208. The plurality of roller pin assemblies may thus create a spiral-shaped winding of the draw wire within the draw wire sensor.

Thus, as is shown in the lateral views of FIGS. 4-6, the draw wire 206 may be wound and unwound around the drum as the drum 208 rotates about the rotating shaft 220 in response to retraction and extension of the movable part, such as the extendable boom of a crane. The point of contact 302, as shown in FIG. 4, may remain at the first end 294 of the drum 208 with respect to the shell 202 as the drum rotates 208. The rotation of the plurality of rollers 218 may facilitate smooth winding and unwinding of the draw wire 206, decreasing friction and thus friction losses.

The outer surface 212 of the drum 208 may be smooth or grooved, depending on the particular application. The lip 222 may act as an upper boundary or border for winding of the draw wire 206. Further, a lower lip 236 may also be included as part of the drum 208 to act as a lower boundary or border for the winding of the draw wire 206. Further, in some examples, the total length of the draw wire 206 may be configured specifically for the upper and lower extension limits of the movable part of the vehicle. For example, the wire may be maximally functionally wound about the drum 208 when the movable part (e.g., boom) is retracted to its lower extension limit and the wire may be minimally functionally wound about the drum 208 when the movable part is extended to its upper extension limit.

During a winding phase, such as when the movable part of the vehicle is extended or retracted, the point of contact 302 may be moved along the width 270 of the drum 208. The contact points along the plurality of rollers 218 may similarly change, but by lesser and variable amounts depending on the distance from the input hole 230 to each given roller (e.g., around the circular path 308). The draw wire sensor 200 herein thus provides for multi-layered wrapping of the draw wire 206, wherein it is first wrapped around the plurality of roller pin assemblies before being wrapped around the drum in a spiral pattern.

Turning now to FIGS. 7-8, the draw wire sensor 200 is shown within housings. FIG. 7 shows a partially cross-sectional view of the draw wire sensor 200 and FIG. 8 shows a perspective view of the draw wires sensor 200. FIG. 7 specifically shows a face shell 702 that is configured to mate with the shell 202 at an interface 706. While not specifically shown herein, the face shell 702 may be coupled to the shell 202 via one or more fasteners, such as screws, clips, or the like. For example, the face shell 702 may comprise a plurality of recesses (not shown) configured to receive the plurality of protrusions 232 of the shell 202. The mating of the plurality of protrusions 232 with the plurality of recesses of the face shell 702 may ensure proper positioning of the face shell 702. The face shell 702 may be configured to effectively cover the drum 208 and the portions of the draw wire 206 that are within the housing.

The face shell 702 may include an opening 704 through which the rotating shaft 220 may be inserted when the face shell 702 is placed over the drum 208. For example, a diameter of the opening 704 may be greater than a diameter of the rotating shaft 220. The rotating shaft 220 may be incorporated or coupled to the sensor device that uses the rotations of the drum 208 to determine the displacement or extension of the movable part of the vehicle. For example, the sensor device may be positioned atop (with respect to the y-axis) a top face 708 of the face shell 702, coupled to the rotating shaft 220. Rotation of the rotating shaft 220 that corresponds to the rotation of the drum 208 may thus be used by the sensor device to determine linear displacement of the movable part of the selected application (e.g., extendable boom of the crane).

FIG. 8 specifically shows the draw wire sensor 200, including a sensor device thereof, in an assembled form. The sensor device, such as a rotary encoder or a potentiometer, as herein described, may be configured to measure linear distances based on transformation of the winding of the draw wire around the drum into an electronic signal. For example, as noted above, the sensor device may be coupled to the rotating shaft, positioned atop the face shell, so as to use the rotation of the drum (and thus the rotating shaft) to determine linear displacement.

In an assembled form, a housing 804 of the draw wire sensor 200 may comprise the shell 202, the face shell 702, and a sensor housing 802. The sensor housing 802 is configured to cover the sensor device and/or any sensor elements (e.g., hardware, circuitry, etc.) used to determine displacement and/or extension of the movable part of the vehicle in which the draw wire sensor is integrated, and to transmit the displacement amount and/or position determined therefrom, to external components. For example, the displacement and position information may be transmitted to a computing device of the vehicle.

The sensor housing 802 may be affixed to the face shell 702 via one or more fasteners 808, such as screws, bolts, or clips. Additionally, a bracket 806 may be coupled to the draw wire sensor 200. For example, the bracket 806 may be affixed to the sensor housing 802 via one or more fasteners 810, such as screws, bolts, or clips. The one or more fasteners 810 that couple the bracket 806 to the sensor housing 802 may also couple the sensor housing 802 to the face shell 702. The bracket 806 may be configured with one or more additional holes 812 configured to receive fasteners to affix the draw wire sensor 200 to another component of the vehicle in which the draw wire sensor 200 is installed (e.g., to the main crane body 102 of crane 100 or to the boom of the crane).

Turning now to FIG. 10, a flowchart illustrating a method 1000 for determining displacement of a movable part, such as a boom of a crane, with a draw wire sensor. The draw wire sensor may be the draw wire sensor 200 described herein or another draw wire sensor that employs the multi-layered spiral winding technique herein disclosed. At least some of the steps of the method 1000 may be executed by one or more processors according to instructions stored in non-transitory memory. For example, the draw wire sensor may comprise a sensor device, such as a rotary encoder or a potentiometer, that includes and/or is coupled to a computing device comprising one or more processors and instructions stored in non-transitory memory.

At 1002, method 1000 includes assembling the draw wire sensor. Assembly of the draw wire sensor may be performed manually and/or via automated machines. Assembly of the draw wire may include affixing an end of a draw wire to a point of the drum and then winding the draw wire around the plurality of roller pin assemblies before feeding the draw wire out the input hole. When the draw wire is affixed to the drum, the drum may be in a fully unwound rotational position. The position of the wire and the amount of wire that is available external to the sensor housing may thus define a fully extended position of the movable part.

At 1004, method 1000 includes arranging the draw wire sensor in a selected application. The selected application may be a heavy equipment application (e.g., crane, excavator, forklift, telescopic loader, etc.), an industrial automation and machinery application (e.g., linear actuators, robotic arms, conveyor systems, etc.), a transportation application (e.g., railway system, automotive testing system, elevator systems, etc.), and the like that includes a movable part, like a telescopic boom. As a non-limiting example, the draw wire sensor may be affixed to an extendable boom of a crane, arranged near a main crane body, as is described herein.

At 1006, method 1000 includes winding and/or unwinding the draw wire via rotation of the drum in response to extension and/or retraction of the movable part of the selected application. As an example, when the extendable boom of the crane is retracted to foreshorten the length of the boom, the drum may rotate. Rotation of the drum may wind the draw wire around the drum, where additional wire that fed into the draw wire sensor through the input hole. During the winding and/or unwinding, the draw wire passes around the plurality of roller pin assemblies before being wound around the drum. As herein described, this effectively increases the free wire length and thus decreases the deflection angle of the wire. The drum may include a spring-loaded element that aids in maintaining the tension of the draw wire as it is wound around the drum, thereby ensuring accurate displacement measurements. The decreased deflection angle may reduce issues with winding.

At 1008, method 1000 includes determining an amount of displacement of the movable part of the selected application based on the winding of the draw wire around the drum. Various methods for determining the displacement based on the winding of the wire are possible. For example, in examples in which the sensor device is potentiometer-based, changes in resistance as the drum rotates may indicate a rotational position of the drum, thus indicating a linear displacement of the movable part. Further, in examples in which the sensor device is encoder-based, optical and/or magnetic encoders may be employed to track rotation of the drum. The raw signal, such as voltage, frequency, or digital pulses, may be processed by the sensor device and/or the computing device to compute the displacement.

The technical effect of the draw wire sensor system herein disclosed is that, by increasing the free wire length via the plurality of roller pin assemblies, the deflection angle of the draw wire sensor may be decreased. A decreased deflection angle may mitigate and/or reduce winding issues which in turn increases the reliability and longevity of the sensor. The plurality of roller pin assemblies are mounted within the sensor housing and create a multi-layered winding in a spiral shape. Mounting the roller pin assemblies within the sensor housing may mitigate the need for increased footprint of the sensor and the increased risk of exposure to the environment as are provided by other methods for increasing the free wire length.

The disclosure also provides support for a draw wire sensor, comprising: a shell comprising an input hole, a drum mounted to the shell, a plurality of roller pin assemblies arranged around the drum, a draw wire configured to enter through the input hole and wind around the plurality of roller pin assemblies before winding around the drum, and a sensor device configured to measure linear distances based on the winding of the draw wire around the drum. In a first example of the system, each of the plurality of roller pin assemblies comprises a pin coupled to the shell and a roller nested around the pin. In a second example of the system, optionally including the first example, the plurality of roller pin assemblies comprises at least six roller pin assemblies. In a third example of the system, optionally including one or both of the first and second examples, the drum is configured to rotate around a rotating shaft. In a fourth example of the system, optionally including one or more or each of the first through third examples, the sensor device is coupled to the rotating shaft. In a fifth example of the system, optionally including one or more or each of the first through fourth examples, the input hole is positioned closer to a first side than a second side of the shell, wherein a first set of roller pin assemblies of the plurality of roller pin assemblies includes at least one roller pin positioned at the first side. In a sixth example of the system, optionally including one or more or each of the first through fifth examples, the plurality of roller pin assemblies follow a circular path with a first diameter greater than a second diameter of the drum. In a seventh example of the system, optionally including one or more or each of the first through sixth examples, the first diameter of the circular path and a width of the drum define a deflection angle of the draw wire.

The disclosure also provides support for a displacement sensor of a vehicle comprising a movable part, comprising: a drum installed on a rotating shaft, a housing comprising a shell coupled to the drum, a face shell coupled to the shell, and a sensor housing coupled to the face shell, wherein the shell comprises an input hole, a plurality of roller pins coupled to the shell, a draw wire affixed to the drum and wound around the plurality of roller pins and around the drum, wherein the draw wire passes through the input hole of the shell, and a sensor device configured to sense displacement of the movable part based on the winding of the draw wire around the drum. In a first example of the system, each of the plurality of roller pins comprises a pin affixed to the shell and a roller arranged around the pin. In a second example of the system, optionally including the first example, each roller is configured to freely rotate around a corresponding pin. In a third example of the system, optionally including one or both of the first and second examples, the plurality of roller pins comprise at least six roller pins arranged in two or more sets. In a fourth example of the system, optionally including one or more or each of the first through third examples, the shell is configured as a square shape with four vertexes, wherein a first set of roller pins is positioned at a first vertex of the shell, a second set of roller pins is positioned at a second vertex of the shell, a third set of roller pins is positioned at a third vertex of the shell, and the input hole is positioned near a fourth vertex of the shell. In a fifth example of the system, optionally including one or more or each of the first through fourth examples, the plurality of roller pins follow a circular path with a first diameter greater than a second diameter of the drum. In a sixth example of the system, optionally including one or more or each of the first through fifth examples, the first diameter of the circular path and a width of the drum define a deflection angle of the draw wire.

The disclosure also provides support for a method of operation of a draw wire sensor in an application, comprising: winding and/or unwinding a draw wire around a drum in response to retraction and/or extension of a movable part of the application, and determining, based on the winding and/or unwinding of the draw wire, a displacement of the movable part, wherein: the draw wire sensor comprises a plurality of roller pin assemblies arranged along a circular path around the drum, wherein the draw wire is wound around the plurality of roller pin assemblies before being wound around the drum in a spiral pattern. In a first example of the method, the plurality of roller pin assemblies and the drum are coupled to a housing of the draw wire sensor. In a second example of the method, optionally including the first example, the plurality of roller pin assemblies are grouped into sets and arranged at vertexes of the housing. In a third example of the method, optionally including one or both of the first and second examples, the housing comprises a shell to which the drum and the plurality of roller pin assemblies are coupled, a face shell coupled to the shell, and a sensor housing coupled to the face shell. In a fourth example of the method, optionally including one or more or each of the first through third examples, determining the displacement of the movable part comprises determining a rotational position of the drum.

FIGS. 1-9 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A draw wire sensor, comprising:
a shell comprising an input hole;
a drum mounted to the shell and installed on a rotating shaft;
a plurality of roller pin assemblies arranged around the drum;
a draw wire configured to enter through the input hole and wind around the plurality of roller pin assemblies before winding around the drum; and
a sensor device coupled to the rotating shaft and positioned to measure linear distances based on the winding of the draw wire around the drum.

2. The draw wire sensor of claim 1, wherein each of the plurality of roller pin assemblies comprises a pin coupled to the shell and a roller nested around the pin.

3. The draw wire sensor of claim 1, wherein the plurality of roller pin assemblies comprises at least six roller pin assemblies.

4. The draw wire sensor of claim 1, wherein the drum is configured to rotate around a rotating shaft.

5. The draw wire sensor of claim 4, wherein the sensor device is coupled to the rotating shaft, wherein the sensor device is one of a potentiometer and a rotary encoder.

6. The draw wire sensor of claim 1, wherein the input hole is positioned closer to a first side than a second side of the shell, wherein a first set of roller pin assemblies of the plurality of roller pin assemblies includes at least one roller pin positioned at the first side.

7. The draw wire sensor of claim 1, wherein the plurality of roller pin assemblies follow a circular path with a first diameter greater than a second diameter of the drum.

8. The draw wire sensor of claim 7, wherein the first diameter of the circular path and a width of the drum define a deflection angle of the draw wire.

9. A displacement sensor of a vehicle comprising a movable part, comprising:
a drum installed on a rotating shaft;
a housing comprising a shell coupled to the drum, a face shell coupled to the shell, and a sensor housing coupled to the face shell, wherein the shell comprises an input hole;
a plurality of roller pins coupled to the shell;
a draw wire affixed to the drum and wound around the plurality of roller pins and around the drum, wherein the draw wire passes through the input hole of the shell; and
a sensor device coupled to the rotating shaft and positioned to determine displacement of the movable part based on the winding of the draw wire around the drum.

10. The displacement sensor of claim 9, wherein each of the plurality of roller pins comprises a pin affixed to the shell and a roller arranged around the pin.

11. The displacement sensor of claim 10, wherein each roller is configured to freely rotate around a corresponding pin.

12. The displacement sensor of claim 9, wherein the plurality of roller pins comprise at least six roller pins arranged in two or more sets.

13. The displacement sensor of claim 12, wherein the shell is configured as a square shape with four vertexes, wherein a first set of roller pins is positioned at a first vertex of the shell, a second set of roller pins is positioned at a second vertex of the shell, a third set of roller pins is positioned at a third vertex of the shell, and the input hole is positioned near a fourth vertex of the shell.

14. The displacement sensor of claim 9, wherein the plurality of roller pins follow a circular path with a first diameter greater than a second diameter of the drum.

15. The displacement sensor of claim 14, wherein the first diameter of the circular path and a width of the drum define a deflection angle of the draw wire.

16. A method of operation of a draw wire sensor in an application, comprising:
winding and/or unwinding a draw wire around a drum in response to retraction and/or extension of a movable part of the application; and
determining, based on the winding and/or unwinding of the draw wire, a displacement of the movable part, wherein:
the draw wire sensor comprises a plurality of roller pin assemblies arranged along a circular path around the drum, wherein the draw wire is wound around the plurality of roller pin assemblies before being wound around the drum in a spiral pattern.

17. The method of claim 16, wherein the plurality of roller pin assemblies and the drum are coupled to a housing of the draw wire sensor.

18. The method of claim 17, wherein the plurality of roller pin assemblies are grouped into sets and arranged at vertexes of the housing.

19. The method of claim 17, wherein the housing comprises a shell to which the drum and the plurality of roller pin assemblies are coupled, a face shell coupled to the shell, and a sensor housing coupled to the face shell.

20. The method of claim 16, wherein determining the displacement of the movable part comprises determining a rotational position of the drum.
